(19) United States
(12) Patent Application Publication
(10) Pub. No.: US 2026/0234039 A1
(43) Pub. Date: Aug. 13, 2026

(54) TIN OXIDE DOPED WITH BISMUTH AND COPPER SEMICONDUCTOR MATERIAL FOR WASTEWATER TREATMENT

(71) Applicant: IMAM ABDULRAHMAN BIN FAISAL UNIVERSITY, Dammam (SA)

(72) Inventor: Imen MASSOUDI, Dammam (SA)

(73) Assignee: IMAM ABDULRAHMAN BIN FAISAL UNIVERSITY, Dammam (SA)

(21) Appl. No.: 19/048,614

(22) Filed: Feb. 7, 2025

(51) Int. Cl. C02F 1/72; B01J 23/843; B01J 35/30; B01J 35/33; B01J 35/39; B01J 35/45; B01J 35/77; B01J 37/03; B01J 37/08; C02F 1/32; C02F 101/30

(52) U.S. Cl. CPC C02F 1/725; B01J 23/8437; B01J 35/33; B01J 35/39; B01J 35/393; B01J 35/394; B01J 35/45; B01J 35/77; B01J 37/031; B01J 37/08; C02F 1/32; C02F 2101/306; C02F 2101/308; C02F 2209/44; C02F 2305/10

(57) ABSTRACT

A semiconductor material is described. The semiconductor material includes tin oxide, bismuth and copper, where the tin oxide is doped with the bismuth and the copper, and where the bismuth is present in an amount of 1 to 5 weight percent (wt. %) based on a total weight of the semiconductor material. The copper is present in an amount of 1 to 5 wt. % based on the total weight of the semiconductor material, and where the tin oxide is in the form of a tetragonal phase with a crystallite size of 15 to 25 nm.

### CROSS REFERENCE TO RELATED APPLICATION

U.S. application titled “SEMICONDUCTOR MATERIAL AND METHOD OF PHOTOCATALYTIC DEGRADATION USING THE SEMICONDUCTOR MATERIAL” Attorney Docket 553077US, filed concurrently with the present application, is incorporated herein by reference in its entirety.

### STATEMENT REGARDING PRIOR DISCLOSURE BY THE INVENTORS

Aspects of the present disclosure are described in Massoudi, I., “Sn_{0.94}Bi_{0.03}X_{0.03}O₂ (X═Cu, Zn) semiconductor compositions: enhanced physical, optical, electrical, dielectric, and photocatalytic properties for the elimination of organic contaminants” published in Journal of Sol-Gel Science and Technology, 110, 690-704 (2024), which is incorporated herein by reference in its entirety.

### STATEMENT OF ACKNOWLEDGEMENT

Support provided by the Basic and Applied Scientific Research Center (BASRC) at Imam Abdulrahman bin Faisal University (IAU) is gratefully acknowledged.

### BACKGROUND

### Technical Field

The present disclosure is directed to wastewater treatment techniques and, more particularly, to a tin oxide doped with bismuth and copper semiconductor material with photocatalysis properties for wastewater treatment.

### Description of Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Various industrial, agriculture, and medical activities produce large quantities of pollutants including hazardous gases (i.e., CO, NO₂, CO₂, and the like) heavy metals (i.e., Pb, As, Cd, Hg, and the like) and/or dissolved organic compounds (i.e., dyes, pesticides, antibiotics, and the like), and release them into the environment. Pollution of water systems and groundwater by organic compounds is a global environmental problem. Dyes and pesticides represent a plurality of mass pollutants in wastewater. Worldwide, 2.5×10⁶ tons of pesticides are consumed every year, and nearly 47.5% of them are herbicide compounds. In the same context, the yearly global production of organic dyes is approximately 7×10⁷ tons. Over 10,000 different kinds of dyes are used by textile industries, and large quantities of these compounds are discharged into the environment as dissolved waste. Pesticides and dyes are very harmful organic contaminants that have great impacts on the environment and human and aquatic life.

Economical techniques, including chemical precipitation, coagulation, ozonation, biological treatment, adsorption, and photocatalysis, which may efficiently remove pollutants from wastewater have been used for treatment. As such, photocatalysis and adsorption are promising techniques due to economically feasible operations and eco-friendliness. A combination of adsorption and photocatalysis properties in a single material leads to an enhanced removal performance for organic waste products [Vimonses, V. et al., An adsorption-photocatalysis hybrid process using multi-functional nanoporous materials for wastewater reclamation, Water Research, 2010, 44, 18, 5385-5397]. A photocatalyst with high adsorption characteristics may support photocatalysis processes by increasing surface reactions between catalyst nanoparticles and molecules of organic waste. In addition, photodegradation of adsorbed organic molecules provides additional active sites that may assist re-adsorption processes. Photocatalysts that possess a low band gap energy and broad absorption properties support high harvesting of visible light radiation. Engineering and synthesis of inexpensive, efficient, eco-friendly, stable, and low band gap photocatalysts may help to remove organic compounds from wastewater. Numerous nanostructured metal oxide semiconductors, such as ZnO, TiO₂, CuO, Bi₂O₃, NiO, and SnO₂, have been used in wastewater treatments. Tin oxide (SnO₂) semiconductors may have desirable properties due to their non-toxicity, corrosion resistance, stability, large oxidation potential, low cost, and eco-friendliness; however, a pure SnO₂ semiconductor has two negative factors, including a wide band gap energy of 3.6 eV, which limits the absorption properties to the ultraviolet region (5% of sunlight spectrum), and a high recombination of photoexcited electrons with holes. Another challenge is that low band gap photocatalysts may suffer from rapid electron-hole recombination, reducing efficiency and long-term stability issues under light exposure, leading to degradation and increased operational costs in wastewater treatment systems. Hence, there is still a need for an efficient and economical method and material for decontaminating wastewater, particularly wastewater polluted by heavy metals and chemically complex toxic dyes.

Accordingly, it is an object of the present disclosure to provide a method for photocatalytic degradation of organic contaminants using a semiconductor material comprising tin oxide doped with bismuth and copper that may circumvent the drawbacks and limitations, such as low stability, poor economic aspects, and low efficiency, of the present methods known in the art.

### SUMMARY

In an exemplary embodiment, a semiconductor material is described. The semiconductor material includes tin oxide, bismuth, and copper. The tin oxide is doped with the bismuth and the copper. The bismuth is present in an amount of 1 to 5 weight percent (wt. %) based on a total weight of the semiconductor material. The copper is present in an amount of 1 to 5 wt. % based on the total weight of the semiconductor material. The tin oxide is in the form of a tetragonal phase with a crystallite size of 15 to 25 nanometers (nm).

In some embodiments, the bismuth is present in an amount of 2 to 4 wt. % based on a total weight of the semiconductor material.

In some embodiments, the copper is present in an amount of 2 to 4 wt. % based on a total weight of the semiconductor material.

In some embodiments, the semiconductor material has a crystallite size of 21 to 25 nm.

In some embodiments, the semiconductor material has a unit cell volume of 71.95 to 72.05 cubic angstroms (Å³).

In some embodiments, the semiconductor material has a band gap of 2.85 to 2.9 electron volts (eV).

In some embodiments, the semiconductor material has a dielectric constant of 3000 to 3500 at a frequency of 50 hertz (Hz).

In some embodiments, the semiconductor material is made by a process including dissolving a tin salt and a copper salt in a first organic solvent to form a first solution, dissolving a bismuth salt in a second organic solvent to form a second solution, mixing the first solution and the second solution and adding a base to form a precipitate. The process further includes calcinating the precipitate at a first temperature of 350 to 450° C. for 30 to 90 minutes and calcinating the precipitate at a second temperature of 550 to 650° C. for 1 to 3 hours to form the semiconductor material.

In another exemplary embodiment, a method of photocatalytic degradation is described. The method includes contacting the semiconductor material with a solution including one or more pollutants, irradiating the solution, and degrading the one or more pollutants in the solution.

In some embodiments, the one or more pollutants are selected from a group of Congo red, imidacloprid, and malachite green.

In some embodiments, the method of irradiating the solution occurs for 5 to 70 minutes.

In some embodiments, the semiconductor material has a photocatalytic efficiency of 90 to 99% based on an initial concentration of the one or more pollutants.

In some embodiments, the semiconductor material has an adsorption activity of 25 to 35% based on an initial concentration of the one or more pollutants.

In some embodiments, the pollutant is Congo red, and the semiconductor material has a photocatalytic efficiency of 96 to 98% based on an initial concentration of Congo red.

In some embodiments, the pollutant is imidacloprid, and the semiconductor material has a photocatalytic efficiency of 92 to 94% based on an initial concentration of the imidacloprid.

In some embodiments, the pollutant is malachite green, and the semiconductor material has a photocatalytic efficiency of 97 to 99% based on an initial concentration of the malachite green.

In some embodiments, the method of irradiating the solution occurs for 60 minutes, and the semiconductor material has a chemical oxygen demand removal of 92 to 96%.

In some embodiments, the method of irradiating the solution occurs for 60 minutes, and the semiconductor material has a total organic carbon removal of 94 to 98%.

In some embodiments, hydroxyl radicals and superoxide anion radicals are involved in the degradation of the one or more pollutants.

In some embodiments, the method of photocatalytic degradation further includes repeating the contacting and the irradiating 2 to 5 times, where the one or more pollutants in the solution are degraded by at least 85% based on an initial concentration of the one or more pollutants.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic flow chart of a method of forming a semiconductor material, according to certain embodiments.

FIG. 1B is a schematic flow chart of a method of photocatalytic degradation, according to certain embodiments.

FIG. 2 depicts X-ray diffraction (XRD) patterns of pure SnO₂ powder (a), (Bi, Cu) co-doped SnO₂ powder (b), and (Bi, Zn) co-doped SnO₂ powder (c), according to certain embodiments.

FIG. 3A is a graph depicting influence of (Bi, Cu) and (Bi, Zn) ions on lattice constant “a” of pure SnO₂ structure, according to certain embodiments.

FIG. 3B is a graph depicting influence of (Bi, Cu) and (Bi, Zn) ions on lattice constant “c” of pure SnO₂ structure, according to certain embodiments.

FIG. 3C is a graph depicting influence of (Bi, Cu) and (Bi, Zn) ions on unit cell volume “V” of pure SnO₂ structure, according to certain embodiments.

FIG. 4 depicts a Williamson-Hall analysis of (Bi, Cu) co-doped SnO₂ powder, according to certain embodiments.

FIG. 5A depicts a crystal structure of a space filling model for Sn_{0.94}Bi_{0.03}Cu_{0.03}O₂, according to certain embodiments.

FIG. 5B depicts a crystal structure of a polyhedral shape of pure SnO₂, according to certain embodiments.

FIG. 6 depicts diffuse reflectance curves of pure SnO₂ powder and (Bi, Cu) and (Bi, Zn) co-doped SnO₂ powder, according to certain embodiments.

FIG. 7 depicts Kubelka-Munk (K-M) function of pure SnO₂ powder and (Bi, Cu) and (Bi, Zn) co-doped SnO₂ powder, according to certain embodiments.

FIG. 8A depicts a scanning electron microscope (SEM) image of pure SnO₂ powder, according to certain embodiments.

FIG. 8B depicts an SEM image of (Bi, Cu) co-doped SnO₂ powder, according to certain embodiments.

FIG. 9 depicts an energy dispersive X-ray spectroscopy (EDS) pattern of (Bi, Cu) co-doped SnO₂ powder, according to certain embodiments.

FIG. 10 depicts EDS elemental mapping of (Bi, Cu) co-doped SnO₂ powder, according to certain embodiments.

FIG. 11 depicts a transmission electron microscopy (TEM) image of (Bi, Cu) co-doped SnO₂ powder with corresponding particle size distribution histogram, according to certain embodiments.

FIG. 12A depicts a relation between frequency and dielectric constant of pure SnO₂ powder and (Bi, Cu) and (Bi, Zn) co-doped SnO₂ powder, according to certain embodiments.

FIG. 12B depicts a relation between frequency and dielectric loss of pure SnO₂ powder and (Bi, Cu) and (Bi, Zn) co-doped SnO₂ powder, according to certain embodiments.

FIG. 13 depicts a relation between frequency and AC electrical conductivity of pure SnO₂ powder and (Bi, Cu) and (Bi, Zn) co-doped SnO₂ powder, according to certain embodiments.

FIG. 14A depicts variation in absorption spectra of a Congo red solution for pure SnO₂ powder under dark and solar irradiation, according to certain embodiments.

FIG. 14B depicts variation in absorption spectra of a Congo red solution for (Bi, Cu) co-doped SnO₂ powder under dark and solar irradiation, according to certain embodiments.

FIG. 15A illustrates variations of concentrations of a Congo red solution after irradiation time (Cₜ) to that of the concentration of a blank solution of contaminants (C₀), Cₜ/C₀, versus time, according to certain embodiments.

FIG. 15B illustrates chemical oxygen demand (COD) and total organic carbon (TOC) removal (%) with (Bi, Cu) co-doped SnO₂, according to certain embodiments.

FIG. 15C illustrates scavenger trapping tests of (Bi, Cu) co-doped SnO₂ for a Congo red solution, according to certain embodiments.

FIG. 16A depicts variation in absorption spectra of a imidacloprid solution for (Bi, Cu) co-doped SnO₂ powder under dark and solar irradiation, according to certain embodiments.

FIG. 16B depicts variation in absorption spectra of a malachite green solution in the presence of (Bi, Cu) co-doped SnO₂ powder under dark and solar energy irradiation, according to certain embodiments.

FIG. 16C depicts a plot of Cₜ/C₀ versus time for an imidacloprid solution in the presence of (Bi, Cu) co-doped SnO₂ powder and a malachite green solution in the presence of (Bi, Cu) co-doped SnO₂ powder, according to certain embodiments.

FIG. 17A depicts reusability of (Bi, Cu) co-doped SnO₂ powder for a Congo red solution under solar energy and xenon irradiation, according to certain embodiments.

FIG. 17B depicts reusability of (Bi, Cu) co-doped SnO₂ powder for an imidacloprid solution under solar energy and xenon irradiation, according to certain embodiments.

FIG. 17C depicts removal efficiency of (Bi, Cu) co-doped SnO₂ powder under solar energy and xenon irradiation, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the words “about,” “approximately,” or “substantially similar” may be used when describing magnitude and or position to indicate that the value and/or position described is within a reasonable expected range of values and/or positions. For example, a numeric value may have a value that is +/−0.1% of the stated value (or range of values), +/−1% of the slated value (or range of values), +/−2% of the stated value (or range of values), +/−5% of the slated value (or range of values), +/−10% of the staled value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term “semiconductor” refers to a substance that possesses electrical conductivity between that of a conductor and an insulator. This conductivity can be manipulated through the introduction of impurities (doping), temperature changes, and/or application of electric fields. Semiconductors typically exhibit electronic properties, enabling them to function as the foundation for electronic devices, such as diodes, transistors, and integrated circuits. Common examples include silicon, germanium, and various compound semiconductors like gallium arsenide. These materials are characterized by a specific bandgap, which allows them to efficiently conduct electricity under certain conditions while remaining insulative under others.

As used herein, the term “photocatalytic degradation” refers to a process by which a photocatalyst facilitates the breakdown of organic contaminants or pollutants under light irradiation. This process involves the photocatalyst absorbing light, leading to the generation of electron-hole pairs. These charge carriers interact with water and oxygen in the environment, producing reactive species such as hydroxyl radicals and superoxide anions. These species subsequently attack and degrade the target pollutants into less harmful substances, resulting in mineralization into carbon dioxide and water.

As used herein, the term “dielectric constant” refers to a ratio of an electric field in a vacuum to an electric field in a dielectric material when subjected to the same electric potential. It quantifies the material's ability to store electrical energy in an electric field, providing insight into its insulating properties and effectiveness in applications such as capacitors and electronic devices.

A weight percent of a component, unless specifically stated to the contrary, is based on a total weight of the formulation and/or composition in which the component is included. For example, if a particular element or component in a composition or article is said to have 5 wt. %, it is understood that this percentage is in relation to a total compositional percentage of 100%.

The present disclosure is intended to include all hydration states of a given compound or formula, unless otherwise noted or when heating a material.

Aspects of the present disclosure are directed toward co-doped SnO₂ semiconductors for enhanced photocatalytic applications in the degradation of environmental pollutants. The present disclosure describes co-doping SnO₂ with bismuth (Bi) and copper (Cu) ions and the optical, electrical, dielectric, adsorption, and photocatalytic properties of the Bi and Cu co-doped SnO₂ material. The synthesized co-doped SnO₂ material is evaluated for efficacy in degrading specific organic contaminants, particularly imidacloprid (a pesticide), Congo red (a dye), and malachite green (dye).

A semiconductor material is described. The semiconductor material includes tin oxide, bismuth, and copper. In some embodiments, the tin oxide may exist in phases such as a cubic phase, an amorphous phase, an orthorhombic phase, a rutile phase, a combination thereof, and the like. In a preferred embodiment, the tin oxide is in the form of a tetragonal phase. The tetragonal phase contributes to effective light absorption and electron transfer, while the nanocrystalline nature enhances overall surface activity. The tetragonal phase is preferably the main phase (at least 50%), preferably at least 75%, more preferably at least 85%, or yet more preferably at least 95% by total phase volume. In a preferred embodiment, the tin oxide is in the form of a tetragonal phase with a crystallite size of 15 to 25 nm, preferably 16 to 24 nm, and more preferably 17 to 23 nm. The semiconductor material may be referred to as a copper-bismuth (Cu, Bi) co-doped SnO₂ powder, a (Cu, Bi) co-doped SnO₂ powder, a (Cu, Bi) co-doped SnO₂ sample, a (Cu, Bi) co-doped SnO₂ catalyst, a Sn_{0.94}Bi_{0.03}Cu_{0.03}O₂ structure, and Sn_{0.94}Bi_{0.03}Cu_{0.03}O₂.

The tin oxide is doped with the bismuth and the copper. The bismuth is present in an amount of 1 to 5 weight percent (wt. %) based on a total weight of the semiconductor material. In some embodiments, the bismuth is present in an amount of 2 to 4 wt. %, preferably 2.5 to 3.5 wt. %, more preferably 2.7 to 2.9 wt. %, and yet more preferably about 2.8 wt. % based on the total weight of the semiconductor material. The copper is present in an amount of 1 to 5 wt. % based on the total weight of the semiconductor material. In some embodiments, the copper is present in an amount of 2 to 4 wt. %, preferably 2.1 to 3 wt. %, more preferably 2.2 to 2.4 wt. %, and yet more preferably about 2.3 wt. % based on the total weight of the semiconductor material. In some embodiments, the bismuth and the copper are present on a surface of the semiconductor material. In other embodiments, the bismuth and the copper are distributed homogeneously throughout the tetragonal phase of SnO₂. In a preferred embodiment, the bismuth and the copper are present on a surface of the semiconductor material, but do not form a layer, and are distributed homogeneously throughout the tetragonal phase of SnO₂.

In some embodiments, the semiconductor material has a crystallite size of 21 to 25 nm, preferably 21.5 to 24.5 nm, preferably 22 to 24 nm, more preferably 22.5 To 23.5 nm, and yet more preferably about 23 nm.

In some embodiments, the semiconductor material has a unit cell volume of 71.95 to 72.05 Å³, preferably 71.96 to 72.04 Å³, preferably 71.97 to 72.03 Å³, preferably 71.98 to 72.02 Å³, more preferably 71.99 to 72.01 Å³, and yet more preferably about 72.0029 Å³.

In some embodiments, the semiconductor material has a band gap of 2.85 to 2.9 eV, preferably 2.86 to 2.89 eV, more preferably 2.87 to 2.89 eV, and yet more preferably about 2.88 eV.

In some embodiments, the semiconductor material has a dielectric constant of 3000 to 3500, preferably 3050 to 3450, preferably 3100 to 3400, preferably 3150 to 3350, more preferably 3200 to 3300, and yet more preferably about 3234 at a frequency of 50 Hz.

In some embodiments, the morphology of semiconductor material may be nanowires, nanospheres, nanocrystals, nanorectangles, nanotriangles, nanopentagons, nanohexagons, nanoprisms, nanodisks, nanocubes, nanoribbons, nanoblocks, nanotoroids, nanodiscs, nanobarrels, nanogranules, nanowhiskers, nanoflakes, nanofoils, nanopowders, nanoboxes, nanobeads, nanobelts, nano-urchins, nanoflowers, nanostars, tetrapods, mixtures thereof, and the like. In some embodiment, the semiconductor material is in the shape of agglomerated spheres.

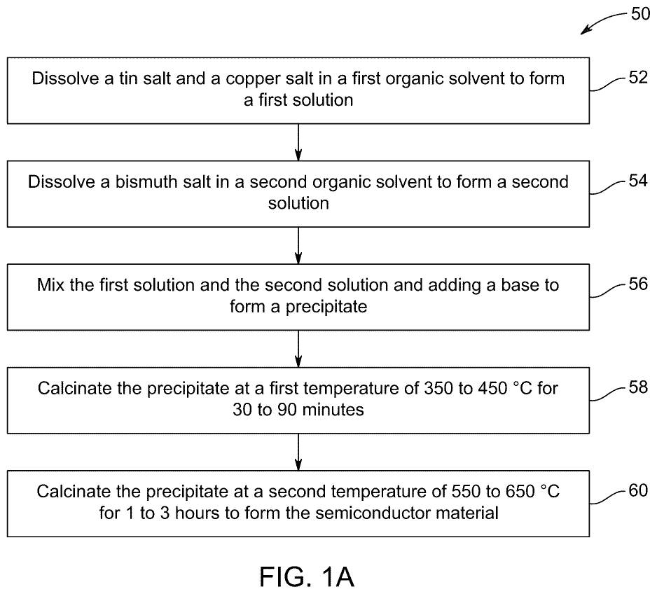

FIG. 1A illustrates a schematic flow chart of a method 50 of making a semiconductor material. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes dissolving a tin salt and a copper salt in a first organic solvent to form a first solution. Suitable examples of tin salts include, but are not limited to, tin(II) chloride, tin(II) sulfate, tin(II) acetate, tin(IV) oxide, tin(IV) fluoride, tin(II) bromide, tin(II) hydroxide, tin(IV) chloride, tin(IV) nitrate, tin(II) carbonate, tin(II) iodide, tin(IV) sulfide, tin(II) phosphonate, tin(IV) acetate, tin(II) oxalate, tin(II) selenite, tin(II) thiocyanate, tin(IV) benzoate, tin(IV) chlorate, tin(II) tartrate, combinations thereof, and the like. In a preferred embodiment, the tin salt is tin chloride.

Suitable examples of copper salts include, but are not limited to, copper(II) sulfate, copper(II) chloride, copper(II) hydroxide, copper(II) nitrate, copper(II) oxide, copper(II) acetate, copper(II) fluoride, copper(II) bromide, copper(II) carbonate, copper(II) carbonate hydroxide, copper(II) chlorate, copper(II) arsenate, copper(II) azide, copper(II) acetylacetonate, copper(II) aspirinate, copper(II) cyanurate, copper(II) glycinate, copper(II) phosphate, copper(II) perchlorate, copper(II) selenite, copper(II) sulfide, copper(II) triflate, copper(II) thiocyanate, copper(II) tetrafluoroborate, copper(II) acetate triarsenite, copper(II) benzoate, copper(II) arsenite, copper(II) chromite, copper(II) gluconate, copper(II) peroxide, copper(II) usnate, copper(II) oxychloride, copper(II) naproxen, copper(II) ibuprofenate, combinations thereof, and the like. In a preferred embodiment, the copper salt is copper nitrate trihydrate.

The tin salt and the copper salt are dissolved in the first organic solvent for a sufficient period to allow for complete dissolution of the tin salt and the copper salt in the first organic solvent. In some embodiments, the first organic solvent may include, but is not limited to, tetrahydrofuran, ethyl acetate, dimethylformamide, acetonitrile, acetone, dichloromethane, toluene, dimethyl sulfoxide, nitromethane, propylene carbonate, ethanol, formic acid, n-butanol, methanol, a combination thereof, and the like. In a preferred embodiment, the first organic solvent is ethanol. In some embodiments, the tin salt and the copper salt may be subjected to some form of agitation like stirring/swirling/shaking for 10 to 120 minutes, preferably 15 to 90 minutes, preferably 20 to 60 minutes, more preferably 25 to 40 minutes, and yet more preferably 30 minutes to form the first solution.

At step 54, the method 50 includes dissolving a bismuth salt in a second organic solvent to form a second solution. Suitable examples of bismuth salts include, but are not limited to, bismuth(III) chloride, bismuth(III) nitrate, bismuth(III) oxide, bismuth(III) sulfate, bismuth(III) acetate, bismuth(III) carbonate, bismuth(III) hydroxide, bismuth(III) bromide, bismuth(III) iodide, bismuth(III) phosphonate, bismuth(III) selenite, bismuth(III) citrate, bismuth(III) sulfide, bismuth(III) tartrate, bismuth(III) acetylacetonate, bismuth(III) arsenate, bismuth(III) benzoate, bismuth(III) thiocyanate, bismuth(III) chlorate, bismuth(III) phosphate, a combination thereof, and the like. In a preferred embodiment, the bismuth salt is bismuth nitrate pentahydrate.

The bismuth salt is dissolved in the second organic solvent to form the second solution. In some embodiments, the second organic solvent may include, but is not limited to, tetrahydrofuran, ethyl acetate, dimethylformamide, acetonitrile, acetone, dichloromethane, toluene, dimethyl sulfoxide, nitromethane, propylene carbonate, ethanol, formic acid, n-butanol, methanol, a combination thereof, and the like. In a preferred embodiment, the second organic solvent is acetone.

At step 56, the method 50 includes mixing the first solution and the second solution and adding a base to form a precipitate. In some embodiments, the first solution and the second solution can be mixed by stirring, swirling, sonicating, or a combination thereof may be employed to form the precipitate. In some embodiments, the base may be selected from a group consisting of an alkaline earth metal hydroxide (i.e., beryllium hydroxide (Be(OH)₂), magnesium hydroxide (Mg(OH)₂), strontium hydroxide (Sr(OH)₂), and calcium hydroxide (Ca(OH)₂)) and an alkali metal hydroxide (i.e., lithium hydroxide (LiOH), sodium hydroxide (NaOH), potassium hydroxide (KOH), rubidium hydroxide (RbOH), and cesium hydroxide (CsOH)).). In some embodiments, the base may be ammonium hydroxide, a pyridine, an alkylamine, an imidazole, a benzimidazole, a histidine, a guanidine, a phosphazene, combinations thereof, and the like. In a preferred embodiment, the base is ammonium hydroxide.

At step 58, the method 50 includes calcinating the precipitate at a first temperature of 350 to 450° C., preferably 360 to 440° C., preferably 370 to 430° C., preferably 380 to 420° C., more preferably 390 to 410° C., and yet more preferably about 400° C. for 30 to 90 minutes, preferably 40 to 80 minutes, more preferably 50 to 70 minutes, and yet more preferably about 60 minutes. The calcination is carried out by heating the precipitate to a high temperature, under a restricted supply of ambient oxygen. This is performed to remove impurities or volatile substances and may be performed to promote thermal decomposition. Typically, the calcination is carried out in a furnace, preferably equipped with a temperature control system.

At step 60, the method 50 includes calcinating the precipitate at a second temperature of 550 to 650° C., preferably 560 to 640° C., preferably 570 to 630° C., preferably 580 to 620° C., more preferably 590 to 610° C., and yet more preferably about 600° C. for 1 to 3 hours, preferably 1.5 to 2.5 hours, and more preferably about 2 hours to form the semiconductor material.

FIG. 1B illustrates a flow chart of a method 70 of photocatalytic degradation. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes contacting the semiconductor material with a solution including one or more pollutants. In some embodiments, the pollutant may be a dye, a phenol, a polycyclic aromatic hydrocarbon, an herbicide, a pesticide, a persistent pollutant, a pharmaceutical composition, a combination thereof, and/or the like.

In some embodiments, the pollutant is a dye. A dye is a colored substance that chemically binds to a material it may be intended to color. Generally, a dye is applied to a solution, typically an aqueous solution. Examples of dyes include, but are not limited to, acridine dyes, which include acridine and its derivatives (i.e., acridine orange, acridine yellow, acriflavine, gelgreen, and the like), anthraquinone dyes, which include anthraquinone and its derivatives (i.e., acid blue 25, alizarin, anthrapurpurin, carminic acid, 1,4-diamno-2,3-dihydroanthraquinone, 7,14-dibenzypyrenequinone, dibromoanthrone, 1,3-dihydroxyanthraquinone, 1,4-dihydroxyanthraquinone, disperse red 9, disperse red 11, indanthrone blue, morindone, oil blue 35, parietin, quinizarine green SS, remazol brilliant blue R, solvent violet 13, 1,2,4-trihydroxyanthraquinone, vat orange 1, vat yellow 1, and the like), diaryl methane dyes (i.e., auramine O, triarylmethane dyes such as acid fuchsin, aluminon, aniline blue WS, aurin, aurintricarboxylic acid, brilliant blue FCF, brilliant green, bromocresol green, bromocresol purple, bromocresol blue, bromophenol blue, bromopyrogallol red, chlorophenol red, coomassie brilliant blue, cresol red, O-cresolphthalein, crystal violet, dichlorofluorescein, ethyl green, fast green FCT, FIAsH-EDT2, fluoran, fuchsine, green S, light green SF, malachite green, merbromin, metacresol purple, methyl blue, methyl violet, naphtholphthalein, new fuchsine, pararosaniline, patent blue V, phenol red, phenolphthalein, phthalein dye, pittacal, spirit blue, thymol blue, thymolphthalein, Victoria blue BO, Victoria blue R, water blue, xylene cyanol, xylenol orange, and the like), azo dyes (i.e., acid orange 5, acid red 13, alican yellow, alizarine yellow R, allura red AC, amaranth, amido black 10B, aniline yellow, arylide yellow, azo violet, azorubine, basic red 18, biebrich scarlet, Bismarck brown Y, black 7984, brilliant black BN, brown FK, chrysoine resorcinol, citrus red 2, congo red, D&C red 33, direct blue 1, disperse orange 1, eriochrome black T, evans blue, fast yellow AB, orange 1, hydroxynaphthol blue, janus green B, lithol rubine BK, metanil yellow, methyl orange, methyl red, methyl yellow, mordant brown 33, mordant red 19, naphthol AS, oil red O, oil yellow DE, orange B, orange G, orange GGN, para red, pigment yellow 10, ponceau 2R, prontosil, red 2G, scarlet GN, Sirius red, solvent red 26, solvent yellow 124, sudan black B, sudan I, sudan red 7B, sudan stain, tartrazine, tropaeolin, trypan blue, yellow 2G, and the like), phthalocyanine dyes (i.e., phthalocyanine blue BN, phthalocyanine Green G, Alcian blue, naphthalocyanine, and the like), azin dyes (i.e., basic black 2, mauveine, neutral red, Perkin's mauve, phenazine, safranin, and the like), indophenol dyes (i.e., indophenol and dichlorophenolindophenol), oxazin dyes, oxazone dyes, thiazine dyes (i.e., azure A, methylene blue, methylene green, new methylene blue, toluidine blue, and the like) thiazole dyes (i.e., primuline, stains-all, thioflavin, and the like), xanthene dyes (i.e., 6-carboxyfluorescein, eosin B, eosin Y, erythosine, fluorescein, rhodamine B, rose bengal, Texas red, and the like) fluorone dyes (i.e., calcein, carboxyfluorescein diacetate succinimidyl ester, fluo-3, fluo-4, indian yellow, merbromin, pacific blue, phloxine, seminaphtharhodafluor, and the like), rhodamine dyes (i.e., rhodamine, rhodamine 6G, rhodamine 123, rhodamine B, sulforhodamine 101, sulforhodamine B, and the like), a combination thereof, and the like. In some embodiments, the one or more pollutants are selected from a group consisting of Congo red, imidacloprid, and malachite green.

At step 74, the method 70 includes irradiating the solution. In some embodiments, the solution may be irradiated using a light source such as mercury vapor lamps, UV-C lamps, metal halide lamps, LED light sources, low-pressure mercury lamps, high-pressure mercury lamps, arc lamps, fluorescent lamps, halogen lamps, carbon arc lamps, incandescent bulbs, near-infrared lasers, UV-LEDs, titanium-dioxide (TiO₂) activated lamps, pulsed light sources, microwave plasma sources, solar simulators, cold cathode lamps, ultraviolet excimer lamps, and the like. In a preferred embodiment, the light source is sunlight or a xenon lamp.

In some embodiments, the solution is irradiated for 5 to 70 minutes, preferably 10 to 70 minutes, preferably 20 to 70 minutes, preferably 30 to 70 minutes, preferably 40 to 70 minutes, more preferably 50 to 70 minutes, and yet more preferably 55 to 65 minutes. In a preferred embodiment, the solution is irradiated for 60 minutes. In some embodiments, before irradiating light, the solution may be mixed in the dark for 1 to 30 minutes, preferably 5 to 30 minutes, 10-30 minutes,

In some embodiments, when the solution is irradiated for 60 minutes, the semiconductor material removes chemical oxygen demand by 92 to 96%, preferably 93 to 95%, and more preferably about 94%. In some embodiments, when the solution is irradiated for 60 minutes, the semiconductor material removes total organic carbon by 94 to 98%, preferably 95 to 97%, and more preferably about 96%.

At step 76, the method 70 includes degrading the one or more pollutants in the solution. Photocatalytic degradation is a process that harnesses light energy to activate a photocatalyst, typically a semiconductor. When illuminated, the photocatalyst absorbs photons, generating electron-hole pairs. The electrons can reduce oxygen molecules, forming reactive oxygen species (ROS) such as hydroxyl radicals, while the holes can oxidize organic pollutants. These ROS effectively break down complex contaminants into simpler, less harmful substances, leading to mineralization into carbon dioxide and water. In some embodiments, hydroxyl radicals and superoxide anion radicals are involved in the degradation of the one or more pollutants.

In some embodiments, the semiconductor material has a photocatalytic efficiency of 90 to 99%, preferably 91 to 98%, preferably 92 to 97%, preferably 93 to 96%, preferably 94 to 95%, based on an initial concentration of the one or more pollutants. In some embodiments, the semiconductor material has an adsorption activity of 25 to 35%, preferably 26 to 34%, preferably 27 to 33%, preferably 28 to 32%, preferably 29 to 31%, based on an initial concentration of the one or more pollutants. In some embodiments, when the pollutant is Congo red, the semiconductor material has a photocatalytic efficiency of 96 to 98%, preferably 96.5 to 97.5%, and more preferably about 97%, based on an initial concentration of Congo red. In some embodiments, when the pollutant is imidacloprid, the semiconductor material has a photocatalytic efficiency of 92 to 94%, preferably 92.5 to 93.5%, and more preferably about 93%, based on an initial concentration of the imidacloprid. In some embodiments, when the pollutant is malachite green, the semiconductor material has a photocatalytic efficiency of 97 to 99%, preferably 97.5 to 98.5%, and more preferably about 98%, based on an initial concentration of the malachite green.

The method 70 optionally includes repeating the contacting and the irradiating 2 to 5 times. In some embodiments, after repeating the contacting, the one or more pollutants in the solution are degraded by at least 85%, preferably at least 90%, preferably at least 95%, and preferably at least 99% based on an initial concentration of the one or more pollutants.

### EXAMPLES

The following examples herein describe and demonstrate a tin oxide doped with bismuth and copper semiconductor material for elimination of various organic contaminants. The examples are provided solely for illustration and are not to be construed as limitations of the present disclosure, as many variations are possible without departing from the spirit and scope of the present disclosure.

### Example 1: Synthesis of Pure Tin Oxide (SnO₂), Bismuth-Copper (Bi, Cu) Co-Doped SnO₂, and Bismuth-Zinc (Bi, Zn) Co-Doped SnO₂

Tin chloride (SnCl₂, ≥99.99%), bismuth nitrate pentahydrate (Bi(NO₃)₃·5H₂O, ≥99.99%), zinc nitrate hexahydrate (Zn(NO₃)₂·6H₂O, ≥99.0%), and copper nitrate trihydrate (Cu(NO₃)₂·3H₂O, 99%) as chemical substances were used to synthesize pure, (Bi, Cu), and (Bi, Zn) co-doped SnO₂ with compositions of Sn_{0.94}Bi_{0.03}Cu_{0.03}O₂ and Sn_{0.94}Bi_{0.03}Zn_{0.03}O₂ via a coprecipitation process. Proper masses of SnCl₂ and Cu(NO₃)₂·3H₂O or Zn(NO₃)₂·6H₂O were dissolved into 100 milliliters (mL) of ethanol under constant stirring for 30 minutes (min). The desired weight of Bi(NO₃)₃·5H₂O was dissolved in acetone and then added to the above described solutions. An ammonium hydroxide solution was added to form precipitates of the dissolved metal ions at pH 7.6. To eliminate the dissolved contaminants like chloride ions, obtained precipitates were intensively washed with deionized water until free of chloride ions. Further, the obtained precipitates were dried, crushed, and calcined at 400° C. for 1 hour followed by calcination at 600° C. for 2 hours (h) under a normal air atmosphere. The physical properties of the obtained powders were characterized by different techniques.

### Example 2: Characterization and Measurements

The crystalline structure and purity of the synthesized pure SnO₂ and (Bi, Cu) and (Bi, Zn) co-doped SnO₂ powders were investigated by X-ray diffraction (XRD) instrument (BrukerMeasSrv (D2−205,530)/D2−205,530, λ=1.5406 Å). To calculate the crystallite size and micro strain, the Williamson-Hall (W-H) method was applied using the XRD data. The particle morphology and elemental composition of pure SnO₂ and (Bi, Cu) and (Bi, Zn) co-doped SnO₂ powders were analyzed via scanning electron microscopy (SEM, FEI Quanta 600 microscope with an SSD detector), transmission electron microscopy (TEM, JEOL JEM2100), and energy dispersive X-ray (EDX) spectroscopy.

Optical features and the band gap energy of pure SnO₂ and (Bi, Cu) and (Bi, Zn) co-doped SnO₂ powders were analyzed by ultraviolet visible (UV-Vis) diffuse reflectance spectrophotometer (model PerkinElmer Lamda-900). Electrical properties of the synthesized samples were measured using a potentiostat/galvanostat/impedance analyzer. Elimination behavior, including adsorption and photocatalysis, of pure SnO₂ and (Bi, Cu) and (Bi, Zn) co-doped SnO₂ powders was measured for 25 mg/L Congo red, imidacloprid, and malachite green under dark and natural sunlight, as well as reactor enclosed in xenon radiation. The influence of the photolysis process (light irradiation without catalyst) for 25 mg/L Congo red, imidacloprid, and malachite green was measured. Experiments for adsorption and photodegradation were performed by adding 50 mg of pure SnO₂ and (Bi, Cu) and (Bi, Zn) co-doped SnO₂ powders to about 100 mL solution of pollutants. Initially, under dark conditions, the mixture solution was stirred for 20 minutes to evaluate the adsorption effect. Further, the solution was illuminated by normal sunlight for about 2 hours at around 12 μm to 2 μm, accompanied by constant stirring. To calculate the value of adsorption and/or photocatalytic efficiency (PE), variation in the absorbance of Congo red, imidacloprid, and malachite green dye was measured at 497 nm, 270 nm, and 617 nm, respectively, using Eq. 1:

$$P E = {A}_{t} / {A}_{0} = {C}_{t} / {C}_{0} \qquad ( 1 )$$

In the aforementioned equation, C₀ indicates the concentration of the blank solution of the contaminants, Cₜ represents the concentration of the solution after the irradiation time, A₀ indicates the absorbance of the blank solution of the contaminants, and Aₜ represents the absorbance of the solution after the irradiation time.

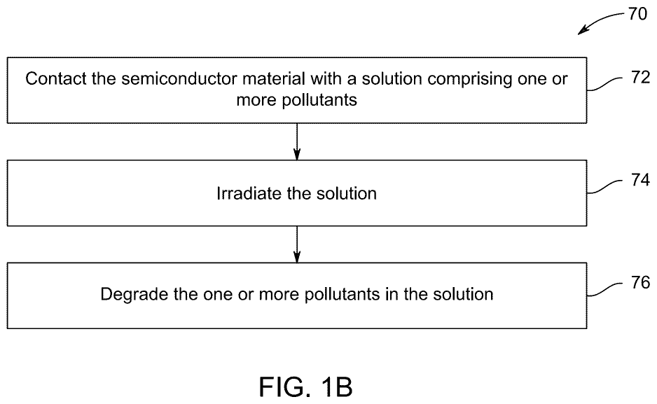

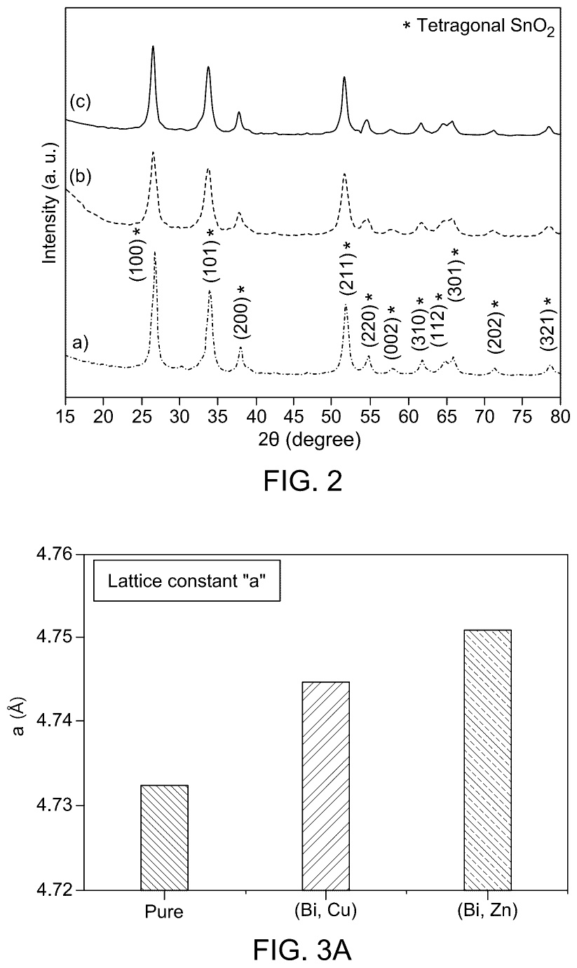

FIG. 2 depicts X-ray diffraction analysis of pure SnO₂ and (Bi, Cu) and (Bi, Zn) co-doped SnO₂ samples prepared at a calcination temperature of 600° C. For the pure SnO₂ sample, XRD peaks were found at 2-theta=26.50°, 33.84°, 37.83°, 51.82°, 56.67°, 57.80°, 61.85°, 64.69°, 65.83°, 71.31°, and 78.68° were indexed to (110), (101), (200), (211), (220), (002), (310), (112), (301), (202), and (321) crystallographic planes, respectively, of tetragonal SnO₂ structure (JCPDS, file number 41-1445). Like the pure SnO₂ samples, Sn_{0.94}Bi_{0.03}Cu_{0.03}O₂ and Sn_{0.94}Bi_{0.03}Zn_{0.03}O₂ compositions exhibited similar XRD peaks with analogous relative intensity. Purity of the samples was determined by no appearance of any foreign XRD peaks in all patterns. To investigate the effect of (Bi, Zn) and (Bi, Cu) ions on the crystal structure of SnO₂, lattice dimensions were analyzed. As shown in FIGS. 3A-3C and Table 1, calculations of lattice parameters and unit cell dimensions display that lattice dimensions of pure SnO₂ were increased owing to the insertion of (Bi, Cu) and (Bi, Zn) ions. These increases may be related to the substitution of Sn⁴⁺ (0.69 Å) sites by Bi³⁺ (1.03 Å), Cu²⁺ (0.73 Å), and Zn²⁺ (0.74 Å) ions. The crystallite size and microstrain of pure SnO₂ and (Bi, Cu) and (Bi, Zn) co-doped SnO₂ samples were analyzed by Williamson-Hall equation (Eq. 2), as shown below [Mote, V. D. et al., Williamson-Hall analysis in estimation of lattice strain in nanometer-sized ZnO particles, J Theoretical Appl Phys, 2012, 6, 6, which is incorporated herein by reference in its entirety]:

$${β}_{hkl} cos {θ}_{hkl} = \frac{K λ}{D} + 4 ε sin {θ}_{hkl} \qquad ( 2 )$$

TABLE 1
Lattice parameters (a, b, c), unit cell volume
(V), chi-square (χ²), Bragg R factor (RB) of pure,
(Bi, Cu) and (Bi, Zn) co-doped SnO₂ powders

| Sample | a (Å) | b (Å) | c (Å) | V (Å³) | χ² | RB |
|---|---|---|---|---|---|---|
| SnO₂ | 4.7324 | 4.7324 | 3.1832 | 71.2901 | 1.8 | 11.3 |
| (Bi, Cu) | 4.7449 | 4.7449 | 3.1981 | 72.0029 | 1.6 | 10.6 |
| (Bi, Zn) | 4.751 | 4.751 | 3.1938 | 72.0918 | 1.9 | 9.9 |

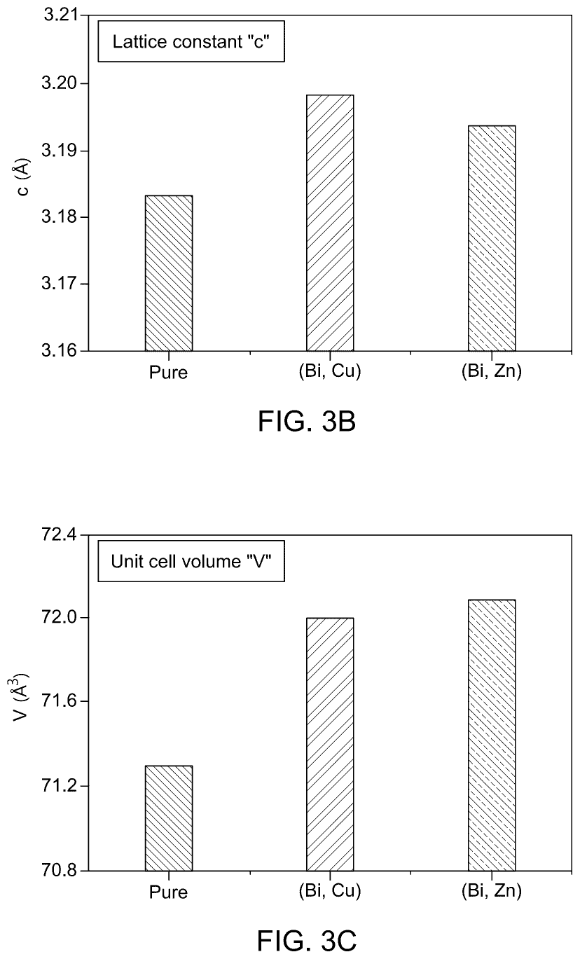

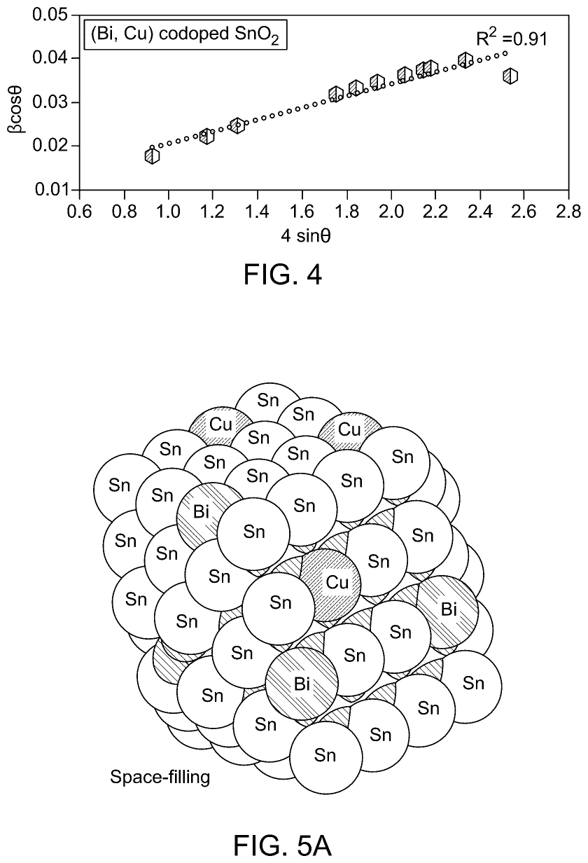

In Eq. 2, βₕₖₗ represents the full width at half maximum of each XRD peak, θₕₖₗ represents the angle of each XRD peak, K is a constant (0.9), λ represents the wavelength of XRD radiation (0.15406 nm), D represents the crystallite size, and ε represents the microstrain. When the values of βₕₖₗ cos θₕₖₗ (y-axis) were plotted against 4ε sin θₕₖₗ (x-axis), the crystalline size (D) of pure SnO₂ and (Bi, Zn) and (Bi, Cu) co-doped SnO₂ samples can be estimated from the y-intercept of linear fit of the data while the microstrain (ε) can be obtained from the slope of the linear fit as, illustrated in FIG. 4. The crystalline sizes of pure SnO₂ and (Bi, Zn) and (Bi, Cu) co-doped SnO₂ samples were 28 nm, 19 nm, and 23 nm, respectively. FIGS. 5A-5B demonstrate an imaginary space filling model of the Sn_{0.94}Bi_{0.03}Cu_{0.03}O₂ structure and the polyhedral shape of pure SnO₂, respectively, which reflect the coordination of the cations.

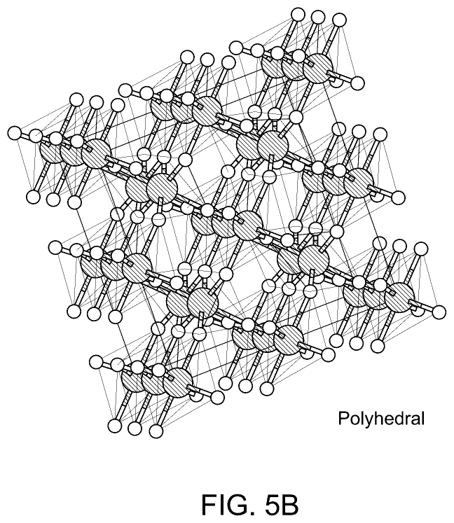

Activity of photocatalytic degradation is related to catalyst absorption of light energy and charge separation of charge carriers. Absorption properties of the metal oxides can be analyzed by a UV-vis infrared (UV-vis-IR) diffuse reflectance technique. FIG. 6 depicts the UV-vis-IR diffuse reflectance spectra of pure SnO₂ and (Bi, Cu) and (Bi, Zn) co-doped SnO₂ powders. Pure SnO₂ powder reveals a high Vis-IR diffuse reflectance intensity from nearly 400 nm to 2100 nm. Under 400 nm (UV region), a large drop in the intensity of the diffuse reflectance was detected, which is correlated to the absorption edge of the SnO₂ semiconductor, as illustrated in FIG. 6. The absorption edge of pure SnO₂ was moderately shifted to low energy direction due to (Bi, Zn) co-doping and strongly shifted in the same direction after incorporation of (Bi, Cu) ions. The obtained UV-vis-IR diffuse reflectance spectra demonstrate that the co-doped samples, especially Sn_{0.94}Bi_{0.03}Cu_{0.03}O₂, have a broad visible light absorption compared to pure SnO₂.

To estimate the band gap energy (E_{g}) values of pure SnO₂ and (Bi, Cu) and (Bi, Zn) co-doped SnO₂ powders, the Tauc relation was employed, as illustrated in Eq. 3 [Koppala, S. et al., Room temperature synthesis of novel worm like tin oxide nanoparticles for photocatalytic degradation of organic pollutants, Mater Sci Energ Technol, 2021, 4, 113-118, which is incorporated herein by reference in its entirety]:

$$α hv = {A ( hv - {E}_{g} )}^{n} \qquad ( 3 )$$

In equation 3, hv represents the photon energy, A represents the energy-independent constant, n is a constant equal to 2 or 3 for indirect allowed and indirect forbidden transition or ½ or 3/2 for direct allowed and direct forbidden transition, respectively. Kubelka-Munk (K-M) function is expressed using equation 4 [Massoudi, I. et al., Effect of Yttrium Substitution on Microstructural, Optical, and Photocatalytic Properties of ZnO Nanostructures, J Electron Mater, 2020, 49, 5353-5362, which is incorporated herein by reference in its entirety]:

$$F ( R ) = \frac{{( 1 - R )}^{2}}{2 R} = \frac{α}{s} \qquad ( 4 )$$

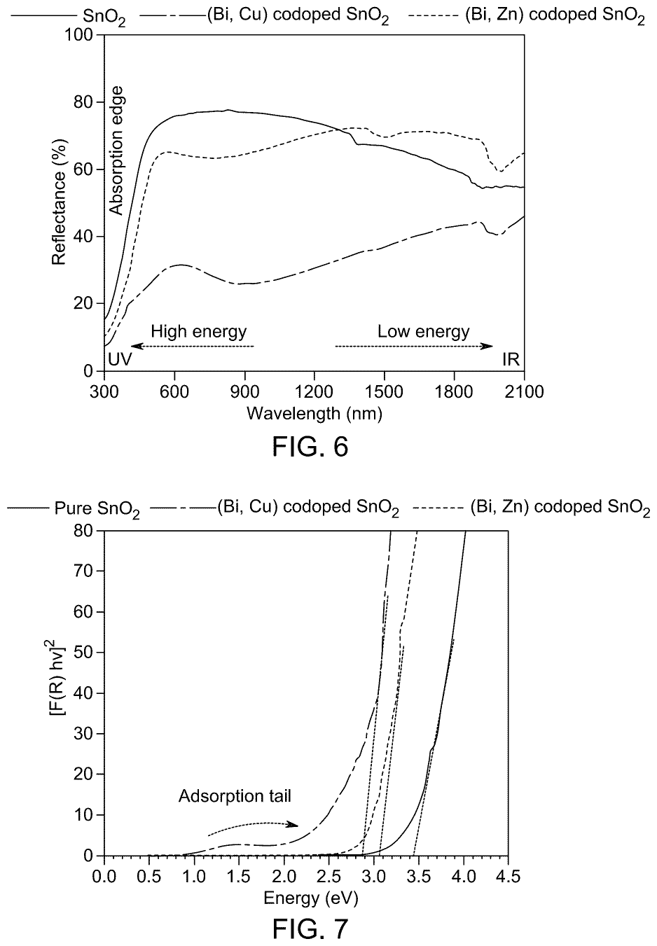

In equation 4, R is the reflectance, a represents the absorption coefficient, and S is the scattering coefficient. S can be considered as a constant (F(R)=α). As illustrated in FIG. 7, the band gap energy of pure SnO₂ powder was found to be 3.45 eV. For (Bi, Cu) and (Bi, Zn) co-doped SnO₂ samples, the band gap energy was 2.88 eV and 3.06 eV, respectively. Furthermore, as can be seen from FIG. 7, the presence of a strong absorption tail extends to 1.2 eV in the case of the (Bi, Cu) co-doped SnO₂ sample. The insertion of (Bi, Zn) ions lead to the formation of a moderate absorption tail to 2.7 eV, as also seen in FIG. 7. Lowering of the band gap energy after insertion of (Bi, Cu) and (Bi, Zn) ions can be clarified based on sp-d exchange interactions between localized d electrons of the Cu²⁺ or Zn²⁺ ions replacing Sn⁴⁺ ions and the band electrons [Babu, B. et al., Enhanced visible light photocatalytic activity of Cu-doped SnO₂ quantum dots by solution combustion synthesis, J Alloys Comp, 2017, 703, 330-336; Le, T. T. H. et al., Fabrication, structural characteristics, and influence of Bi³⁺ doping concentration on UV-vis spectra of Bi³⁺:SnO₂ nanocomposite materials, Vietnam J Sci Technol Eng, 2023, 65, 09-13; and Xu B. et al., Structural and optical properties of Zn-doped SnO₂ films prepared by DC and RF magnetron co-sputtering, Superlattices Microstructure, 2016, 89, 34-42, which are incorporated herein by references in their entireties]. The p-d exchange interactions increase valence band edges while the s-d exchange interactions reduce conduction-band edges, resulting in a low band gap energy. For balance of charge, insertion of Bi³⁺, Cu²⁺, and/or Zn²⁺ ions replacing Sn⁴⁺ cations introduce oxygen vacancies as defects that support the lowering in the band gap. Overall optical results support (Bi, Cu) co-doped SnO₂ powder has optical characteristics appropriate for photocatalytic applications.

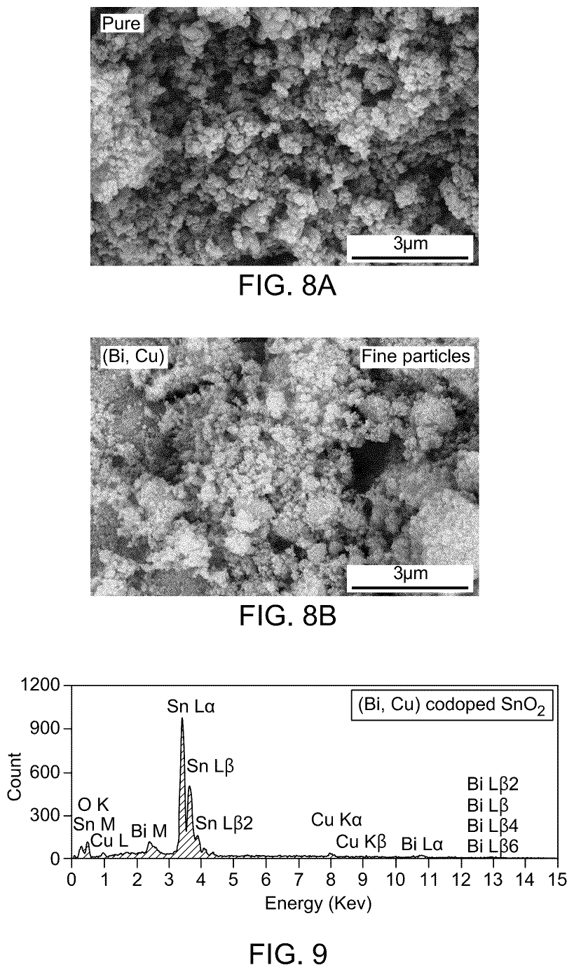

FIGS. 8A-8B illustrate the surface morphology based on a scanning electron microscopy (SEM) analysis of pure SnO₂ powder and (Bi, Cu) co-doped SnO₂ powder. The SEM images of the samples demonstrate the synthesis of spherical particles has a homogenous distribution. The addition of (Bi, Cu) ions make the particles more fine compared to pure SnO₂ powder. The presence of (Bi, Cu) ions restrict the grain growth of SnO₂ powder [Yakout, S. M., Robust ferromagnetic and fast sunlight photocatalytic properties of nanocrystalline SnO₂:Co/Cu codoping, Ceramics Int, 2021, 47, 10104-10112, which is incorporated herein by reference in its entirety].

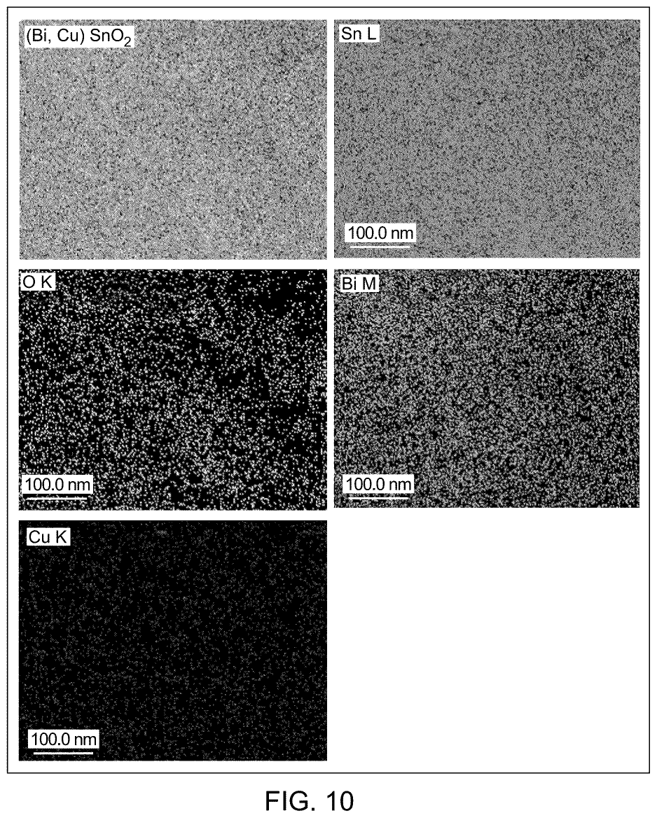

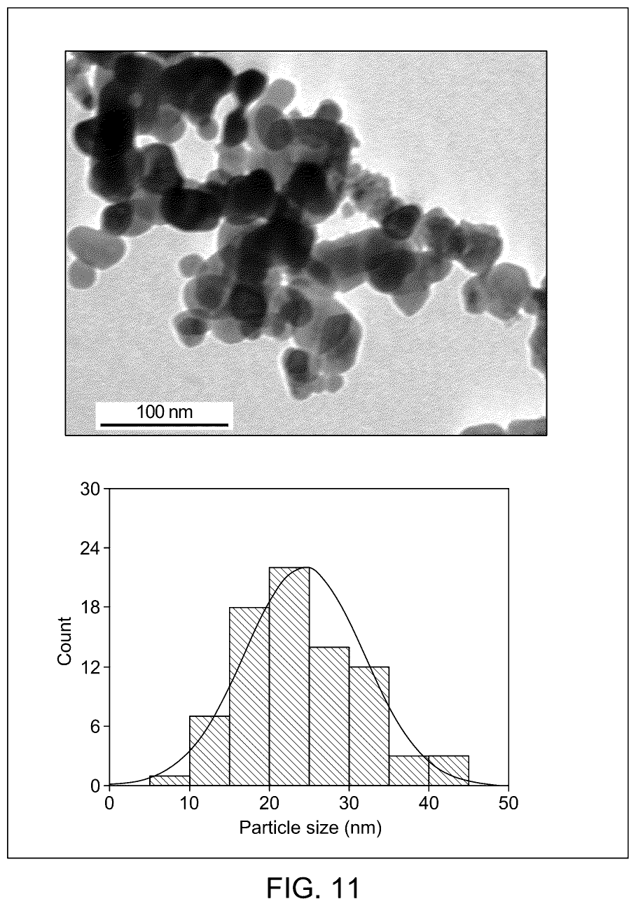

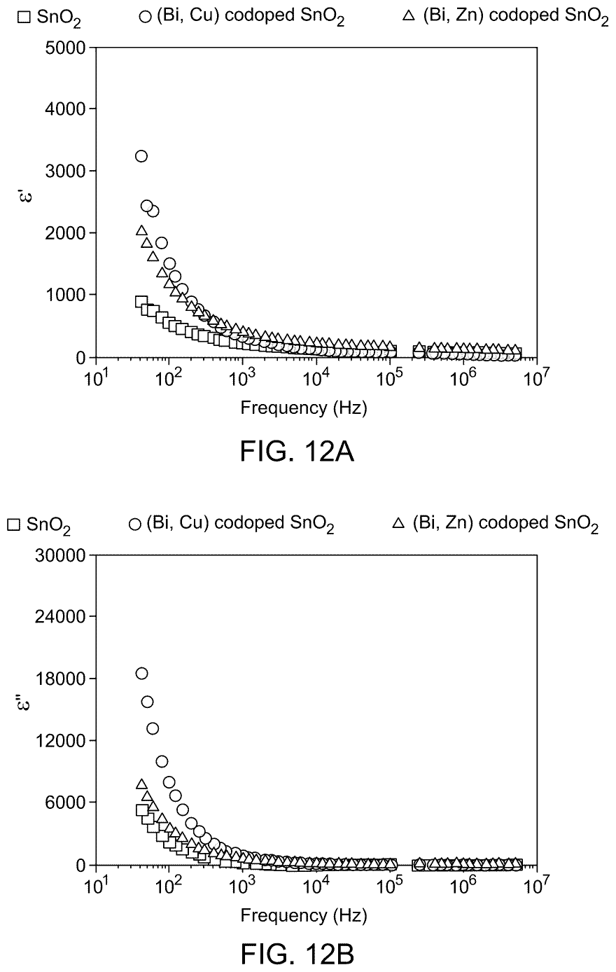

As shown in FIG. 9, an energy dispersive X-ray spectroscopy (EDS) analysis of (Bi, Cu) co-doped SnO₂ powder indicates the presence of tin(Sn) and oxygen (O) as major elements with bismuth (Bi) and copper (Cu) as dopants. The percentage weights (wt. %) of the Bi and Cu into Sn_{0.94}Bi_{0.03} Cu_{0.03}O₂ structure were 2.8 wt. % and 2.3 wt. %. The energy dispersive X-ray (EDS) mapping of (Bi, Cu) co-doped SnO₂ powder is illustrated in FIG. 10. The obtained images support the homogeneous distribution of Bi and Cu dopants inside the Sn_{0.94}Bi_{0.03}Cu_{0.03}O₂ structure. The transmission electron microscopy image of (Bi, Cu) co-doped SnO₂ powder with corresponding particle size distribution histogram is shown in FIG. 11. The image reveals that the powder includes nanosized semi-spherical particles with an average size of 22 nm.

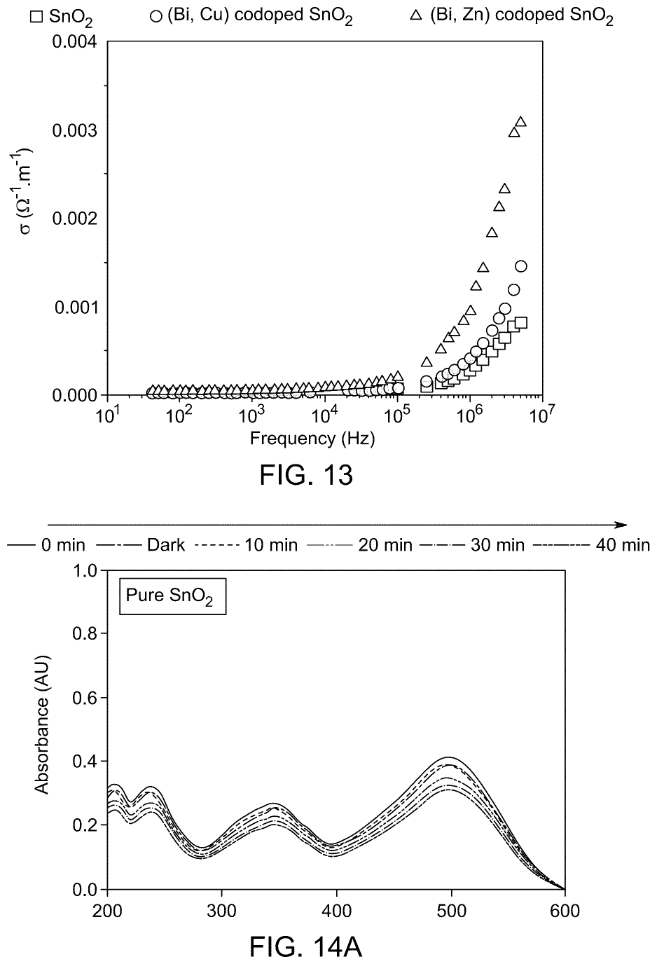

FIG. 12A depicts the influence of frequency on the dielectric constant of pure SnO₂ powder and (Bi, Cu) and (Bi, Zn) co-doped SnO₂ powder. The samples show rapid decrease in the dielectric constant with increasing frequency, particularly at low values. The maximum dielectric constant was achieved at the lowest frequency with an estimated value of pure SnO₂ powder equal to 883 at 50 Hz. The additives of (Bi, Cu) and (Bi, Zn) ions increased the dielectric constant of the SnO₂ powder at low frequencies with maximum values at 50 Hz of 3234 and 2023, respectively. The results show that the incorporation of (Bi, Cu) ions develops the dielectric energy storage function of the SnO₂ sample. The behavior of the dielectric constant with frequency can be interpreted by Maxwell-Wagner (M-W) interfacial response [Parveen, A. et al., Room temperature variation in dielectric and electrical properties of Mn doped SnO₂ nanoparticles, Materials Today Proc., 2017, 4, 9429-9433; and Zulfiqar, U. R. et al. Dielectric and ferromagnetic properties of (Ni, Co) co-doped SnO₂ nanoparticles, J Mater Sci: Mater Electron, 2021, 32, 19859-19870, which are incorporated herein by references in their entireties]. As established by the M-W interfacial response, the powder of the oxides or the perovskite materials can be considered to include two separate regions with conductivity. The dielectric material is composed of conducting grain regions detached by poorly conducting grain boundary regions.

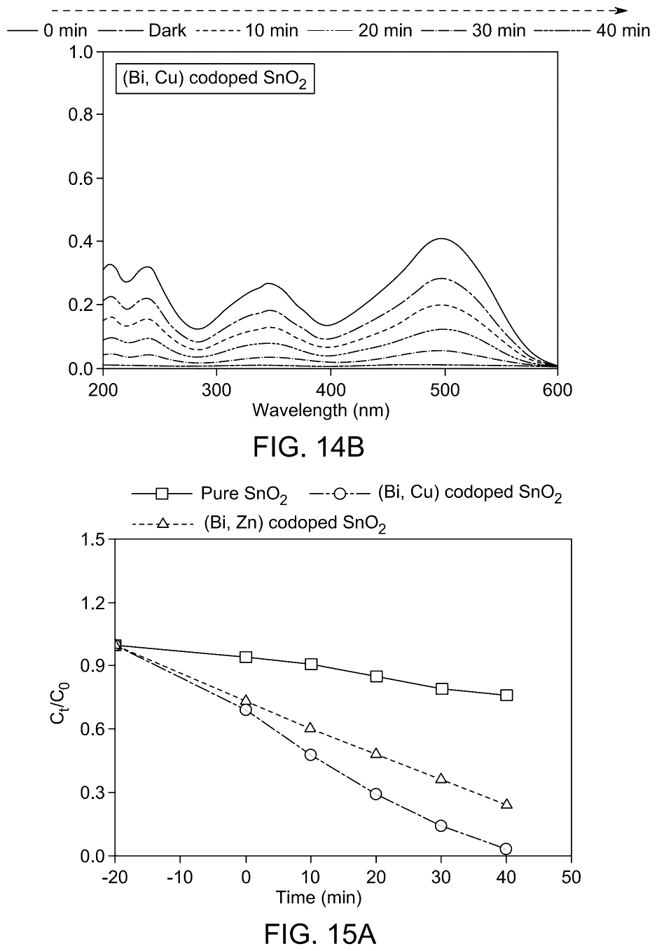

Under the application of an electric field, owing to the high resistivity of grain boundary regions, charge carriers are accumulated at low frequency. Accumulation of these charge carriers at grain boundaries induce a large polarization, which leads to high relative permittivity (dielectric constant). Impact of grain boundary regions are dominated at lower frequencies while the conducting grains are operative at the higher frequencies. FIG. 12B depicts the effect of frequency on the dielectric loss of pure SnO₂ powder and (Bi, Cu) and (Bi, Zn) co-doped SnO₂ powder. Dielectric loss of all samples was decreased with increasing frequency, which is similar to the dielectric constant performance. The highest dielectric loss was found for (Bi, Cu) co-doped SnO₂ and the lowest value was measured for pure SnO₂. FIG. 13 illustrates the dependence of AC electrical conductivity on frequency for pure SnO₂ powder and (Bi, Cu) and (Bi, Zn) co-doped SnO₂ powder. The plots display that the electrical conductivity of all samples was improved with increasing the applied frequency, mainly at higher frequencies. High values of electrical conductivity at higher frequencies can be attributed to a large motivating force that is transported to electrons at these high frequencies. It can be noticed that the additives of (Bi, Cu) and (Bi, Zn) ions improve the AC electrical conductivity of the SnO₂ structure, particularly the mixture of (Bi, Cu) dopants. These enhancements can be ascribed to the progress of the hopping rate between charge carriers [Parveen, A. et al., Room temperature variation in dielectric and electrical properties of Mn doped SnO₂ nanoparticles, Materials Today Proc., 2017, 4, 9429-9433; and Zulfiqar, U. R. et al. Dielectric and ferromagnetic properties of (Ni, Co) co-doped SnO₂ nanoparticles, J Mater Sci: Mater Electron, 2021, 32, 19859-19870, which is incorporated herein by references in their entireties].

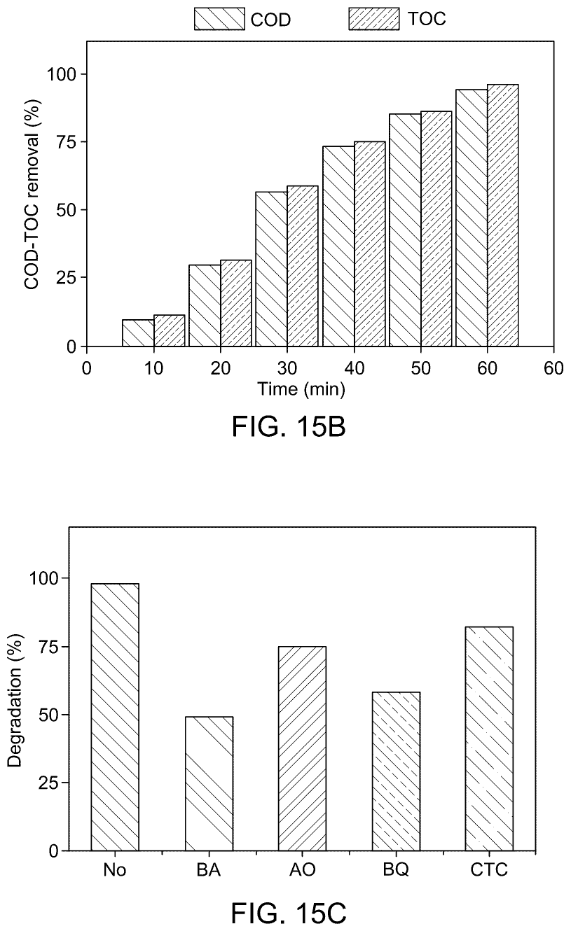

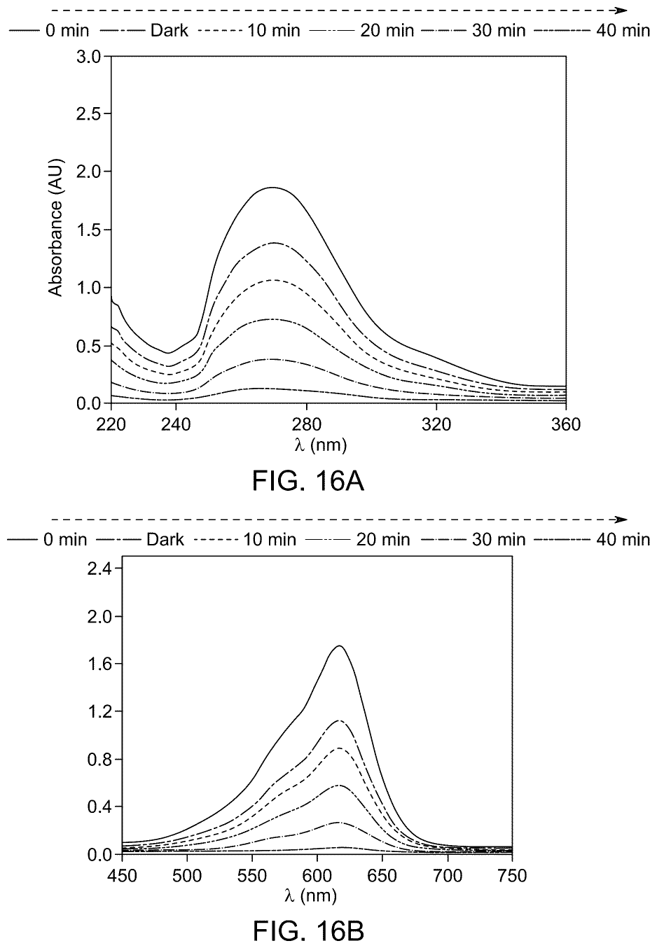

The removal activity of pure SnO₂ powder and (Bi, Cu) and (Bi, Zn) co-doped SnO₂ powder was evaluated for three organic contaminants, including two dyes (Congo red and malachite green) and one pesticide (imidacloprid), under dark and solar energy. The effect of self-degradation under sunlight radiation (without catalyst) for the three contaminants after two hours is negligible (<0.4%). FIGS. 14A-14B display variation of absorbance spectra for a Congo red solution (25 mg/L) with pure SnO₂ powder and (Bi, Cu) co-doped SnO₂ powder over time. Pure SnO₂ powder shows a slight decrease in the absorbance spectrum of Congo red under dark conditions stirring for 20 minutes followed by sunlight irradiation for 40 minutes. The adsorption of pure SnO₂ powder was 5% while the photocatalytic activity under solar light was 24% after 40 minutes of irradiation. The decreases in absorbance of Congo red were enhanced for (Bi, Cu) co-doped SnO₂ powder, with a measured adsorption and photocatalytic activity of 31% and 97%, respectively. After finishing the photodegradation of Congo red with (Bi, Cu) co-doped SnO₂ powder, the catalyst ((Bi, Cu) co-doped SnO₂ powder) was collected via centrifugation (11,000 rpm) and then placed into a beaker containing 100 mL distilled water under ultrasonic vibration for 40 minutes. No variation of the color of the water was observed, demonstrating degradation of Congo red dye and that the adsorption factor boosts the photodegradation of Congo red molecules on the surface of the powder. These results support the high elimination features of (Bi, Cu) co-doped SnO₂ powder. FIG. 15A depicts the change of C₀/Cₜ versus time of pure SnO₂ powder and (Bi, Cu) and (Bi, Zn) co-doped SnO₂ powder versus the time of irradiation. The plots show the large decreases of C₀/Cₜ over time for (Bi, Cu) co-doped SnO₂ powder, signifying the large and rapid adsorption and photocatalytic activity of this catalyst. The elimination efficacy of (Bi, Cu) co-doped SnO₂ catalyst may be accredited to intense visible light harvesting, good charge carrier separation, and the role of adsorption through increasing the surface reaction between the catalyst and pollutant. The optical properties illustrate that the band gap energy of the SnO₂ catalyst was reduced from 3.45 eV to 2.88 eV along with the formation of a long tail prolonged to 1.2 eV with the incorporation of (Bi, Cu). For the balance of the charge, the additives of Bi³⁺ and Cu²⁺ ions to the SnO₂ lattice increase the oxygen vacancies. The produced oxygen vacancies may act as centers for trapping the electrons which impede the recombination of charge carriers, leading to further enhancements in the photocatalytic activity. FIG. 15B displays the change in the percentage of the chemical oxygen demand (COD) and total organic carbon (TOC) in the presence of the (Bi, Cu) co-doped SnO₂ catalyst. These analyses are used to calculate mineralization of organic materials to H₂O and CO₂ (simple products). As shown in FIG. 15B, the removal percentages of COD and TOC increase with time of treatment with an effectiveness of 94% and 96% in 60 minutes, respectively, establishing a large mineralization activity of this catalyst. Photodegradation steps may be determined by the charge carriers involving electrons (e⁻) and holes (h⁺) in addition to the reactive radicals, including superoxide anion (O_{2′}⁻) and the hydroxyl radical (·OH). The superoxide anion (O_{2′}⁻) is the product of the reaction between e⁻ and oxygen molecules in the waste solution while the hydroxyl radical (·OH) is the product of the reaction between h⁺ and a water molecule. To estimate the reactive species in the photocatalytic activity, scavengers containing benzoic acid (BA), ammonium oxalate (AO), benzoquinone (BQ), and carbon tetrachloride (CTC) were individually added to the Congo red dye solution to capture ·OH, h⁺, O_{2′}⁻, and e⁻, respectively [Liu, W. et al., Synergistic adsorption-photocatalytic degradation effect and norfoxacin mechanism of ZnO/ZnS@BC under UV-light irradiation, Scientific Rep, 2020, 10, 11903; Huang, S. et al., Steering charge kinetics of tin niobate photocatalysts: Key roles of phase structure and electronic structure, Nanoscale Res Lett, 2018, 13, 161, which are incorporated herein by references in their entireties]. As shown in FIG. 15C, the photodegradation efficiency was decreased from 97% (without scavenger) to 49%, 75%, 58%, and 82% after the addition of BA, AO, BQ, and CTC, respectively. Based on these values, the hydroxyl (·OH) and the superoxide anion (O₂⁻) radicals are the most prevalent species in photocatalytic activity of Congo red dye using (Bi, Cu) co-doped SnO₂ catalyst.

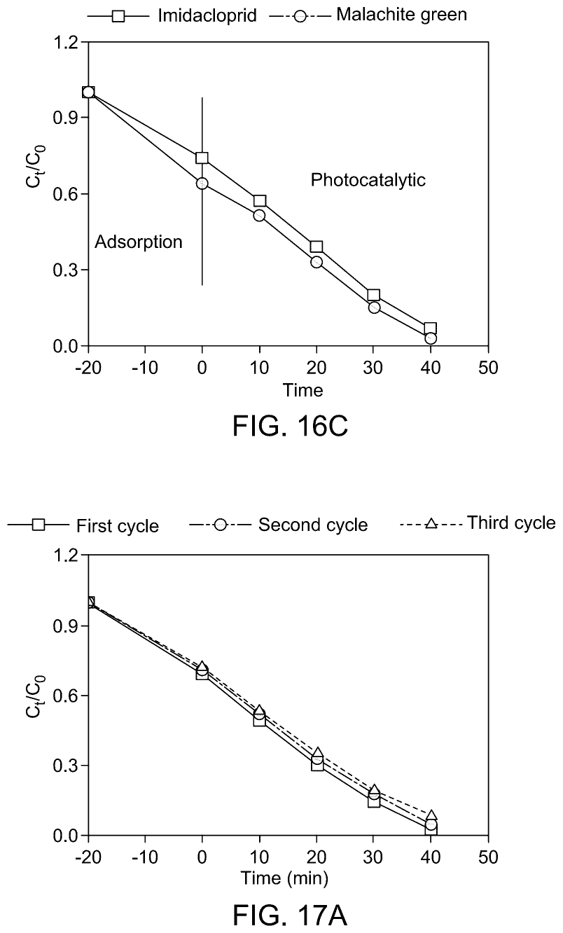

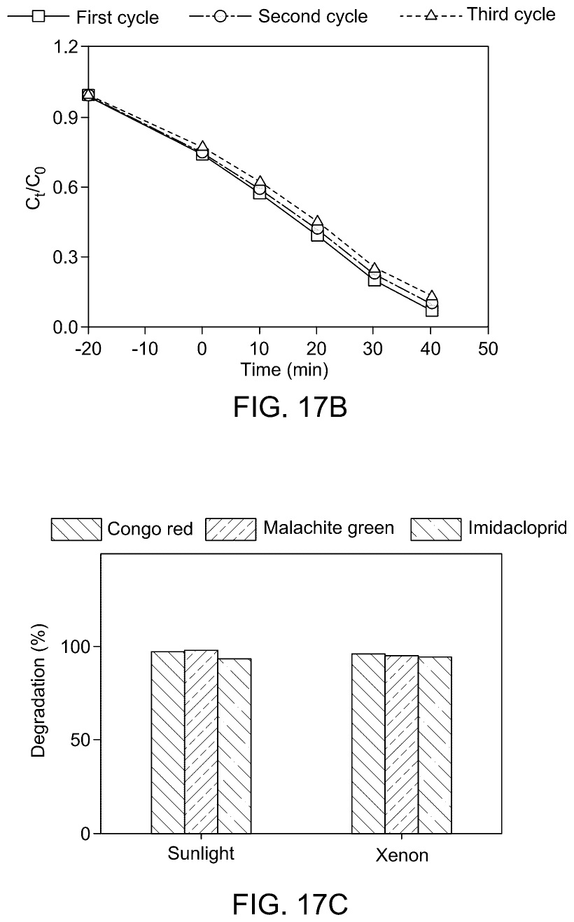

The adsorption and photocatalytic activity of the (Bi, Cu) co-doped SnO₂ catalyst were investigated for additional organic waste products including, imidacloprid as a pesticide (25 mg/L) and malachite green (25 mg/L). FIGS. 16A-16B demonstrate the changes in the absorbance curves of imidacloprid and malachite green dye, respectively. The absorbance curve of imidacloprid was decreased under dark and sunlight irradiation with a measured adsorption activity and photocatalytic activity of 26% and 93%, respectively. For malachite green, the measured adsorption activity and photocatalytic activity were 36% and 98%, respectively. As illustrated in FIG. 16C, the plot of C₀/Cₜ versus time illuminates the large decreases of C₀/Cₜ for imidacloprid and malachite green in the presence of the (Bi, Cu) co-doped SnO₂ catalyst, showing the large and rapid adsorption and photocatalytic activity of this catalyst. The multiuse of the photocatalyst may be applied in economically wastewater treatment. As illustrated in FIGS. 17A-17B, the reusability results of (Bi, Cu) co-doped SnO₂ powder towards Congo red and imidacloprid were plotted, respectively. After finishing the primary (first) photocatalytic experiment, the powder of (Bi, Cu) co-doped SnO₂ catalyst was obtained via centrifugation and, after that, it was utilized again for the next test. After three tests, the total removal efficiency of (Bi, Cu) co-doped SnO₂ catalyst for Congo red was 97%, 95%, and 92%, respectively. For imidacloprid, the elimination efficiency of the (Bi, Cu) co-doped SnO₂ catalyst was 93%, 90%, and 87% for the first, second, and third cycles, respectively. The reusability measurements of both contaminants support the stability of the (Bi, Cu) co-doped SnO₂ catalyst for multi-depollution processes. The influence of an irradiation source on the photocatalytic activity of (Bi, Cu) co-doped SnO₂ catalyst for the three investigated pollutants was evaluated using xenon and sunlight radiation, as shown in FIG. 17C. The recorded removal efficiency of Congo red was 96% and 97%, the removal efficiency of malachite green was 96% and 98%, and the removal efficiency for imidacloprid was 94% and 93% under xenon and sunlight radiation, respectively. The obtained photocatalytic efficiency was compared with previous studies, as shown in Table 2. The comparison reflects the efficient photocatalytic activity of the synthesized (Bi, Cu) co-doped SnO₂ catalyst. Based on the results of the scavenger tests, the chemical oxygen demand percentage (COD %), and the total organic carbon percentage (TOC %), the mechanism of the degradation may be determined. The scavenger tests illustrate that the hydroxyl (·OH) and the superoxide anion (O_{2′}⁻) radicals are the main species in the photodegradation mechanism. Both TOC and DOC results support the high mineralization of the organic pollutants to CO₂ and H₂O molecules under sunlight irradiation. When the particles of (Bi, Cu) co-doped SnO₂ catalyst are exposed to light energy in waste solutions, the electrons are excited to the conduction band and holes are formed in the valence band. The electrons and holes react with oxygen/water molecules to form O_{2′}⁻ and ·OH radicals, respectively. Both radicals attack the Congo red, imidacloprid, and/or malachite green as a noxious waste to yield CO₂ and H₂O [Chandran, D. et al., Structural, optical, photocatalytic, and antimicrobial activities of cobalt-doped tin oxide nanoparticles, J Sol-Gel Sci Technol, 2015, 76, 582-591; Thambiliyagodage, C. and Mirihana, S., Photocatalytic activity of Fe and Cu co-doped TiO₂ nanoparticles under visible light, J Sol-Gel Sci Technol, 2021, 99, 109-121; and Yi, W. et al., A new perspective for effect of S and Cu on the photocatalytic activity of S, Cu-codoped nano-TiO₂ under visible light irradiation, J Sol-Gel Sci Technol, 2014, 69, 386-396, each of which are incorporated herein by references in their entireties]:

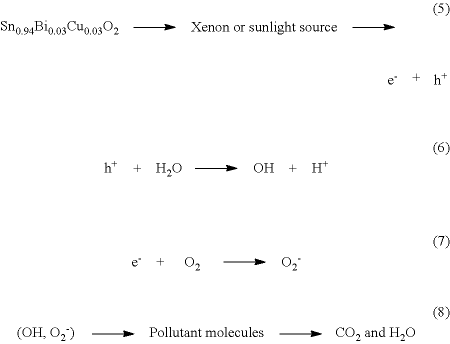

The total results for the three pollutants prove the encouraging removal properties of (Bi, Cu) co-doped SnO₂ catalyst for industrial wastewater remediation.

TABLE 2
Photocatalytic properties of (Bi, Cu) co-doped SnO₂ with literature

| | | Efficiency | Time | |
|---|---|---|---|---|
| Sample | Pollutant | (%) | (min) | Reference |
| Sn_{0.94}Bi_{0.03}Cu_{0.03}O₂ | Congo red | 97 | 40 | Current |
| | | | | invention |
| Sn_{0.94}Bi_{0.03}Cu_{0.03}O₂ | Imidacloprid | 93 | 40 | Current |
| | | | | invention |
| Sn_{0.94}Bi_{0.03}Cu_{0.03}O₂ | Malachite | 98 | 40 | Current |
| | green | | | invention |
| Cr doped SnO₂ | Malachite | 60.37 | 120 | 1 |
| | green | | | |
| Sb doped SnO₂ | Methylene | 80 | 120 | 2 |
| | orange | | | |
| Co-doped SnO₂ | Methylene | 95.38 | 120 | 3 |
| | blue | | | |
| Tb doped SnO₂ | Methylene | 97-100 | 60 | 4 |
| | blue | | | |
| Cu doped SnO₂ | Rhodamine B | 100 | 60 | 5 |
| Mn-doped SnO₂ | Congo red | 78 | 120 | 6 |
| Pd doped SnO₂ | Rhodamine B | 87 | 120 | 7 |

(1) Senthilkumar, P. et al., Optoelectronic, photocurrent sensitivity and photocatalytic dye degradation behaviour of spray deposited Cr doped SnO₂ thin films, Mater Chem Phys, 2023, 305, 127988; (2) Ahmad, T. and Ansari, M. Z., Structural and optical characteristics of Sb doped SnO₂ nanoparticles and their boosted photocatalytic activity under visible light irradiation, Ceramics Int, 2023, 49, 35740-35756; (3) Ragupathy, S. et al., Enhanced sun light driven photocatalytic activity of Co doped SnO₂ loaded corn cob activated carbon for methylene blue dye degradation, Chemosphere, 2022, 295, 133848, (4) Kolokolov, D. et al., Multifunctional Tb-doped SnO₂ based photocatalytic agent for water remediation: Study of defect-related properties, Ceramics Int, 2023, 49, 34901-34919; (5) Arif, M. et al., High photocatalytic performance of copper-doped SnO₂ nanoparticles in degradation of Rhodamine B dye, Opt Mater, 2022, 134, 113135; (6) Rajeswaran, P. et al., A simple fabrication of Mn doped SnO₂ nano particles towards improved Congo red degradation photo-catalytic activity, Mater Today: Proceedings, 2023, 80, 634-640; and (7) Madhan, D. et al., Visible light photocatalytic activity of pure and palladium (Pd) doped SnO₂ nanoparticles by a one step facile route, J Mater Sci: Mater Electron, 2017, 28, 14453-14459, each of which are incorporated herein by reference in their entireties.

(Bi, Cu) co-doped SnO₂ catalyst demonstrated high de-pollution properties for three organic wastes, including Congo red, imidacloprid, and malachite green, under solar energy. Pure SnO₂ powder and (Bi, Cu) co-doped SnO₂ powder was prepared via precipitation. XRD analysis of compositions reveal the formation of a tetragonal SnO₂ phase with a crystallite size range from 17 to 23 nm. SEM images of pure SnO₂ powder and (Bi, Cu) co-doped SnO₂ powder demonstrate the synthesis of highly fine spherical particles. EDX mapping of the (Bi, Cu) co-doped SnO₂ sample illustrate the regular distribution of Bi and Cu dopants. Co-doping of (Bi, Cu) ions reduced the band gap of SnO₂ powder from 3.45 eV (UV region) to 2.88. Insertion of (Bi, Cu) ions into the SnO₂ semiconductor demonstrate a strong visible light tail reached 1.2 eV. The (Bi, Cu) co-doped SnO₂ catalyst demonstrate photocatalytic activities of 97%, 93%, and 98% for Congo red, imidacloprid, and malachite green after 40 minutes, respectively. The measured results for Congo red, imidacloprid, and malachite green pollutants support the promising performance of the (Bi, Cu) co-doped SnO₂ catalyst for industrial wastewater treatment.

Numerous modifications and variations of the present disclosure are possible considering the above teachings. Therefore, it is to be understood that within the scope of the appended claims, the disclosure may be practiced other than as specifically described herein.

1: A semiconductor material, comprising:
tin oxide;
bismuth; and
copper,
wherein the tin oxide is doped with the bismuth and the copper,
wherein the bismuth is present in an amount of 1 to 5 weight percent (wt. %) based on a total weight of the semiconductor material,
wherein the copper is present in an amount of 1 to 5 wt. % based on the total weight of the semiconductor material, and
wherein the tin oxide is in the form of a tetragonal phase with a crystallite size of 15-25 nm.

2: The semiconductor material of claim 1, wherein the bismuth is present in an amount of 2 to 4 wt. % based on a total weight of the semiconductor material.

3: The semiconductor material of claim 1, wherein the copper is present in an amount of 2 to 4 wt. % based on a total weight of the semiconductor material.

4: The semiconductor material of claim 1, wherein the semiconductor material has a crystallite size of 21 to 25 nm.

5: The semiconductor material of claim 1, wherein the semiconductor material has a unit cell volume of 71.95 to 72.05 Å³.

6: The semiconductor material of claim 1, wherein the semiconductor material has a band gap of 2.85 to 2.9 eV.

7: The semiconductor material of claim 1, wherein the semiconductor material has a dielectric constant of 3000 to 3500 at a frequency of 50 Hz.

8: The semiconductor material of claim 1, wherein the semiconductor material is made by a process, comprising:
dissolving a tin salt and a copper salt in a first organic solvent to form a first solution;
dissolving a bismuth salt in a second organic solvent to form a second solution;
mixing the first solution and the second solution and adding a base to form a precipitate;
calcinating the precipitate at a first temperature of 350 to 450° C. for 30 to 90 minutes; and
calcinating the precipitate at a second temperature of 550 to 650° C. for 1 to 3 hours to form the semiconductor material.

9: A method of photocatalytic degradation, comprising:
contacting the semiconductor material of claim 1 with a solution comprising one or more pollutants;
irradiating the solution; and
degrading the one or more pollutants in the solution.

10: The method of claim 9, wherein the one or more pollutants are selected from a group consisting of Congo red, imidacloprid, and malachite green.

11: The method of claim 9, wherein the irradiating occurs for 5 to 70 minutes.

12: The method of claim 9, wherein the semiconductor material has a photocatalytic efficiency of 90 to 99% based on an initial concentration of the one or more pollutants.

13: The method of claim 9, wherein the semiconductor material has an adsorption activity of 25 to 35% based on an initial concentration of the one or more pollutants.

14: The method of claim 10, wherein the one or more pollutants is Congo red and the semiconductor material has a photocatalytic efficiency of 96 to 98% based on an initial concentration of the Congo red.

15: The method of claim 10, wherein the one or more pollutants is imidacloprid and the semiconductor material has a photocatalytic efficiency of 92 to 94% based on an initial concentration of the imidacloprid.

16: The method of claim 10, wherein the one or more pollutants is malachite green and the semiconductor material has a photocatalytic efficiency of 97 to 99% based on an initial concentration of the malachite green.

17: The method of claim 11, wherein the irradiating occurs for 60 minutes and the semiconductor material has a chemical oxygen demand removal of 92 to 96%.

18: The method of claim 11, wherein the irradiating occurs for 60 minutes and the semiconductor material has a total organic carbon removal of 94 to 98%.

19: The method of claim 9, wherein hydroxyl radicals and superoxide anion radicals are involved in the degradation of the one or more pollutants.

20: The method of claim 9, further comprising:
repeating the contacting and the irradiating 2 to 5 times,
wherein the one or more pollutants in the solution are degraded by at least 85% based on an initial concentration of the one or more pollutants.
